(19) United States
(12) Patent Application Publication
(10) Pub. No.: US 2026/0336547 A1
(43) Pub. Date: Oct. 29, 2026

(54) Energy Absorption Element for Supporting a Bumper Crossmember on a Body of a Motor Vehicle

(71) Applicant: Bayerische Motoren Werke Aktiengesellschaft, Muenchen (DE)

(72) Inventors: Lino CESCOLINI, Muenchen (DE); Simone CHIRRA, Mering (DE); Oliver HUCK, Ergolding (DE); Manuel SCHROEDER, Oberhaching (DE)

(21) Appl. No.: 19/111,602

(22) PCT Filed: Aug. 16, 2023
(86) PCT No.: PCT/EP2023/072592

§ 371 Date: Mar. 13, 2025

(30) Foreign Application Priority Data
Sep. 14, 2022 (DE) 10 2022 123 416.9

(51) Int. Cl. B60R 19/34

(52) U.S. Cl. CPC B60R 19/34

(57) ABSTRACT

An energy absorption element for supporting a bumper crossmember on a body of a motor vehicle includes a flange plate that can be supported on the body side, and at least one base body connected to the flange plate. The base body forms a box profile via respective lateral legs, an upper leg and a lower leg, which at least substantially delimit a cavity. In order to ensure that the bumper crossmember is particularly supported on the body of the motor vehicle even when the energy absorption element is arranged higher in relation to the vertical direction of the vehicle, respective lateral leg parts of the base body protrude downwards in relation to the lower leg of the box profile.

### BACKGROUND AND SUMMARY

The invention relates to an energy absorption element for supporting a bumper crossmember on a body of a motor vehicle. The invention further relates to a fastening arrangement for fastening such an energy absorption element to a body of a motor vehicle.

An energy absorption element of this kind and also its fastening arrangement for its fastening to a body of a motor vehicle are already known, for example, from DE 20 2020 005 403U1. For example, in that case a bumper crossmember is supported on and fastened to the rear end of the body of the motor vehicle by means of two energy absorption elements of this kind. Each of the energy absorption elements in that case comprises a flange plate supportable on the body side, by means of which flange plate the corresponding energy absorption element can be supported on the rear end of a laterally corresponding rear side member. In addition, the respective energy absorption element comprises a main body connected to the flange plate, which main bodies were previously formed usually from two reshaped parts or extruded profiles that are substantially U-shaped in cross section and that form a box profile by respective lateral limbs, an upper limb and a lower limb, which box profile delimits a cavity at least substantially on the outer periphery side.

On account of various circumstances, for example vehicle wheels with increasing tire sizes, higher build-on vehicle derivatives or the like, the respective energy absorption elements and the corresponding bumper crossmembers, in particular rear crossmembers, are in the meantime higher than in earlier times. This means that the impact point of respective barriers, which are used to simulate various collisions, for example rear-end collisions, with obstacles and accident partners, no longer hits the center of the bumper crossmember, in this case in particular the rear-end crossmember, in the vertical direction of the vehicle, but rather below it. This may result in a torque acting on the bumper crossmember and the energy absorption elements, causing the respective energy absorption elements to tilt away downwards in the vertical direction of the vehicle if no appropriate countermeasures are taken. In extreme cases, this may lead to increased intrusion into corresponding body-in-white structures of the vehicle. It is usually not possible to displace the respective energy absorption element downwards, as this would cause problems during assembly or result in a lack of overlap with the associated rear side member.

On the other hand, it is imperative to dissipate the forces acting on the bumper crossmember via the corresponding energy absorption elements in order to prevent damage to the body-in-white, for example due to deformation of a corresponding end plate, such as a rear end plate. In the event of a rear-end collision, for example, it is also important to avoid damaging a corresponding tailgate.

It is therefore the object of the present invention to provide an energy absorption element and a fastening opening of the type mentioned above, by means of which accident forces acting in the longitudinal direction of a vehicle in the event of a collision of the motor vehicle can be absorbed and supported in an improved manner by the respective energy absorption elements or damage to the body-in-white of the motor vehicle can be prevented as far as possible.

According to the invention, this object is achieved by an energy absorption element and by a fastening opening of such an energy absorption element having the features of the independent claim(s). Favorable developments of the invention are the subject of the dependent claims.

The energy absorption element according to the invention for supporting a bumper crossmember on a body of a motor vehicle comprises a flange plate which can be supported on the body side and which is connected to a main body of the energy absorption element or supports it against the body of the motor vehicle. The main body here comprises respective lateral limbs, an upper limb and a lower limb, which together form a box profile that at least substantially delimits a cavity. Here, this box profile is preferably formed by two sheet metal shell components, but other embodiments are also conceivable in principle.

In order to ensure here that the bumper crossmember is supported particularly favorably even when the energy absorption element is arranged higher on the body of the motor vehicle in relation to the vertical direction of the vehicle, so that, in the event of a collision of the motor vehicle with accident forces acting in the longitudinal direction of the vehicle, there can be no excessive application of torque or downward tilting of the energy absorption elements in the vertical direction of the vehicle, it is provided according to the invention that respective lateral limb parts of the main body protrude downwards relative to the lower limb of the box profile. By means of the respective lower, lateral limb parts, which extend below the lateral limbs of the box profile in the vertical direction of the vehicle, the bumper crossmember is therefore also braced in a lower region of the bumper crossmember in relation to the vertical direction of the vehicle, so that, in the event of an accident-related application of force with an accident force acting in the longitudinal direction of the vehicle, this is also very well supported in the lower region and therefore cannot be subjected to a torque and thus the bumper crossmember together with the associated energy absorption elements does not tilt downwards in the vertical direction of the vehicle. Rather, the respective lower, lateral limb parts of the main body ensure that such tilting of the bumper crossmember and the energy absorption elements is avoided by creating a particularly favorable support of the bumper crossmember in its lower height region.

At the same time, such support of the bumper crossmember in its lower height region means the energy absorption elements cannot tilt and therefore fail, but that a respective box profile can therefore be used in an optimum manner to absorb accident energy. In addition, the respective lower lateral limb parts enable the flange plate to be mounted on the body in a particularly favorable manner, so that, for example, a fastening opening in the lower region of the flange plate remains accessible despite the provision of the respective lower lateral limb parts and, as a result, the flange plate or the entire energy absorption element can still be connected to the body of the motor vehicle, in particular an end plate of the body-in-white or a side member arranged in the extension of the respective energy absorption element, in a favorable manner.

Overall, it can therefore be seen that in the present case the main body of the energy absorption element is extended downwards in the vertical direction of the vehicle by the respective lateral limb parts so that a better overlap with a respective barrier, a swinging link or the like, which for example simulates an obstacle or an accident partner, so that no tilting of the bumper crossmember or of the energy absorption element can occur and no increased torque can be introduced into the side member supporting the respective energy absorption element, which might lead to excessive damage of the body-in-white structure.

In a further embodiment of the invention, it is provided that the lateral limbs and the upper limb of the main body, which thus form the upper region of the box profile, are formed by an upper sheet metal shell component and the lateral limb parts and the lower limb of the main body are formed by a lower sheet metal shell component. The two sheet metal shell components can thus be produced in a particularly favorable manner by appropriate reshaping, in particular hot forming, and can be formed, for example, by a corresponding welded connection, in particular by MAG welding.

A further advantageous embodiment of the invention provides for the lateral limb parts below the box profile to protrude laterally relative to the lateral limbs of the box profile in the transverse direction of the vehicle. This results in even more favorable support of the bumper crossmember. In addition, this also results, for example, in particularly favorable accessibility to a lower fastening opening of the flange plate, by means of which the energy absorption element is bolted on to the body-in-white.

A further advantageous embodiment of the invention provides that the upper sheet metal shell component is connected to the lower sheet metal shell component at the lower ends of the lateral limbs via respective joint connections, in particular welded connections. This results in a particularly stable assembly of the two sheet metal shell components.

A further advantageous embodiment of the invention provides that the lower sheet metal shell component is connected to the lower ends of the lateral limbs of the upper sheet metal shell component in the region of respective limbs running obliquely downwards from the welded connections. Due to the obliquely downwardly running flanks, an optical water run-off from the box profile is ensured here, so that no corrosion can form there.

In a further advantageous embodiment of the invention, the upper sheet metal shell component and the lower sheet metal shell component are provided with different trigger beads. The deformation behavior and energy absorption capability of the energy absorption element can thus be optimally adjusted by means of the trigger beads.

A further advantageous embodiment of the invention provides that a lower fastening opening is arranged on the underside of the lower limb and inside the two lower limb parts. This makes it possible to fix the respective energy absorption element to the body of the motor vehicle in a particularly favorable and simple manner.

The advantages described above in conjunction with the energy absorption element according to the invention also apply to the fastening arrangement according to claim 8. In a favorable embodiment of the invention, it is furthermore provided here that the lower sheet metal shell component of the main body protrudes downwards relative to a side member of the body of the motor vehicle, on which the respective energy absorption element is at least indirectly arranged. This is a particularly favorable way of preventing the respective energy absorption element from tilting.

Further features of the invention can be found in the claims, the figures and description of the figures. The features and combinations of features mentioned above in the description and the features and combinations of features mentioned below in the description of the figures and/or shown alone in the figures can be used not only in the combination indicated in each case, but also in other combinations or on their own.

The invention will now be explained in greater detail with reference to a preferred exemplary embodiment and with reference to the drawings.

### BRIEF DESCRIPTION OF THE DRAWINGS

FIG. 1 is a perspective view of a rear end of a body of a passenger car, in which a fastening arrangement of a rear bumper crossmember is provided rearwards of a rear end plate by means of respective energy absorption elements according to the invention;

FIG. 2 is a perspective view, enlarged in comparison to FIG. 1, of the rear bumper crossmember, which can be seen in detail and which, by means of the left-hand energy absorption element, is supported on the rear end plate or on the lateral side member arranged in front of it on the laterally assigned vehicle side as viewed in the direction of forward travel;

FIG. 3 is a perspective view of a detail of the rear bumper crossmember and the temporally associated energy absorption element viewed obliquely from behind;

FIG. 4 is a further perspective view of a part of the bumper crossmember and of the laterally assigned energy absorption element on the left as seen in the direction of forward travel, viewed from the center of the vehicle obliquely towards the rear;

FIG. 5 is a perspective sectional view through a main body of the energy absorption element along a sectional plane running in the vertical direction of the vehicle or in the transverse direction of the vehicle; and

FIG. 6 is a side view of the fastening arrangement for fastening the rear bumper crossmember to the rear of the motor vehicle body by means of the relevant laterally associated energy absorption element.

### DETAILED DESCRIPTION OF THE DRAWINGS

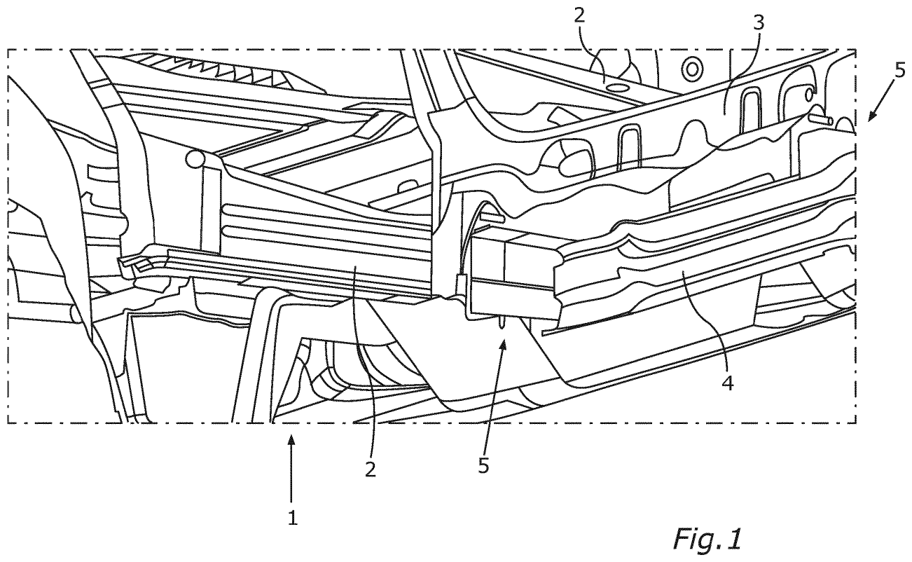

FIG. 1 shows a perspective view of a detail of a rear end 1 of a body of a passenger motor vehicle. In particular, a rear side member 2 on each side of the vehicle can be seen here, which ends rearwards at a rear end plate 3 in the longitudinal direction of the vehicle. The fastening arrangement for fastening a rear bumper crossmember 4 by means of respective energy absorption elements 5 on each side of the vehicle can be seen rearwards of the rear end plate 3.

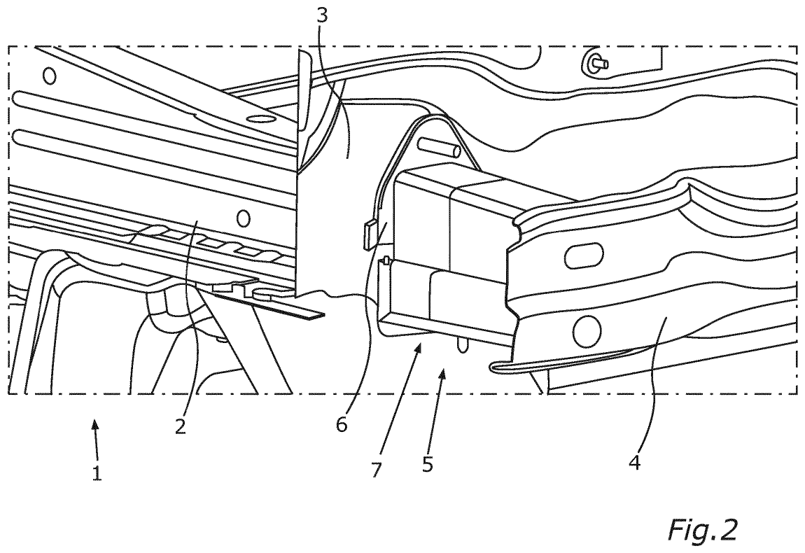

In conjunction with FIG. 2, which shows the left end region of the bumper crossmember 4-viewed in the direction of forward travel- and the laterally associated energy absorption element 5 in a detailed perspective view obliquely from behind which is enlarged compared to FIG. 1, it can be seen that this energy absorption element 5 is arranged at least substantially in overlap or in extension of the relevant laterally assigned rear side member 2, both in the vertical direction of the vehicle and in the transverse direction of the vehicle.

If, for example, the motor vehicle is involved in a rear-end collision with an accident partner, the accident forces registered via the bumper crossmember 4 and acting substantially in the longitudinal direction of the vehicle are at least partially absorbed or introduced into the body of the passenger motor vehicle by means of the two respective lateral energy absorption elements 5.

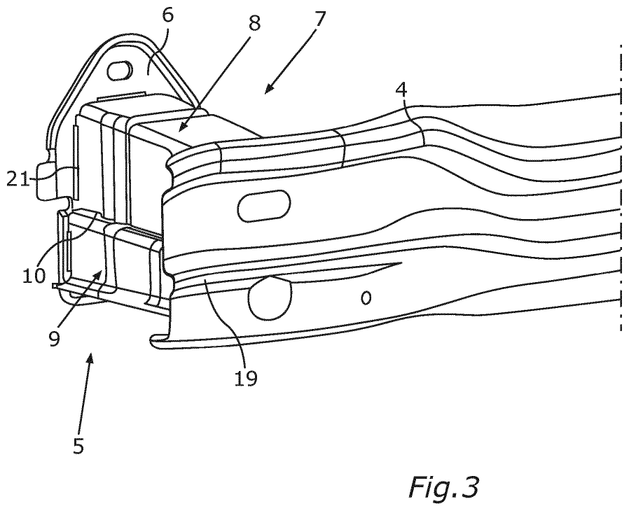

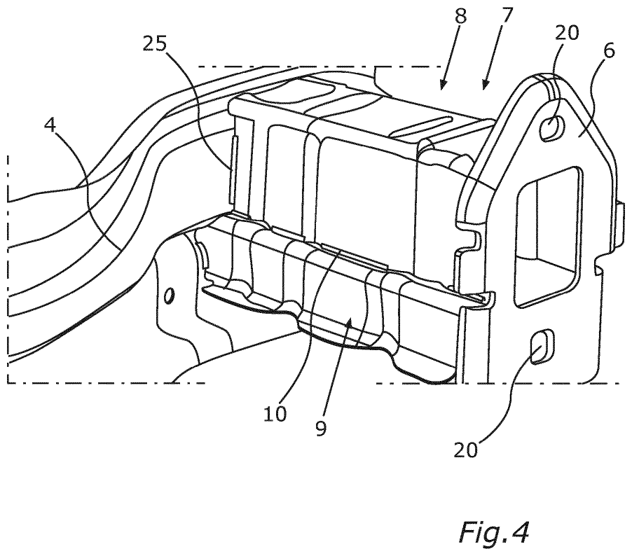

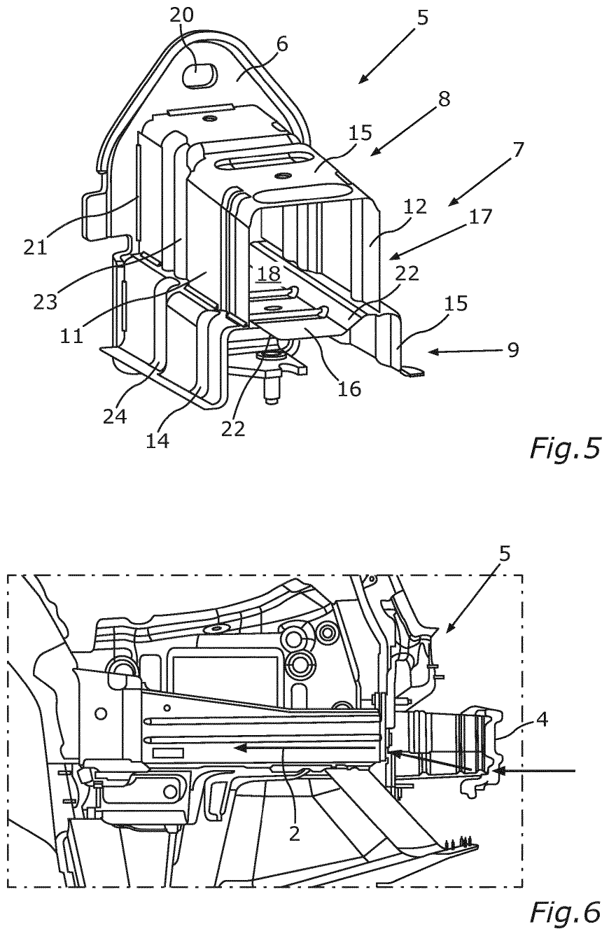

With reference to FIGS. 3 and 4, which each show the left-hand energy absorption element 5—viewed in the direction of forward travel—in respective perspective views obliquely outwards from behind or from the center of the vehicle outwards towards the rear, it can be seen that the respective energy absorption element 5 is formed from a flange plate 6, which is supported or can be supported on the body side, and a main body 7, which is supported on this flange plate 6 or connected to it. This main body 7 is particularly easy to recognize in FIG. 5, in which the energy absorption element 5 is shown in a perspective sectional view along a plane of section running in the vertical direction of the vehicle or in the transverse direction of the vehicle in the region of the main body 7. In particular, it can be seen here that the main body 7 is formed by an upper sheet metal shell component 8 and a lower sheet metal shell component 9, which are connected in a manner described in greater detail below by means of respective welded connections, in particular respective MAG welded connections.

The upper sheet metal shell component 8 is at least substantially in the form of an inverted O-shape in cross section and comprises respective lateral limbs 11, 12, which are connected to each other in one piece via an upper limb 13. The lateral limbs 11, 12 extend here substantially vertically in the vertical direction of the vehicle and in the longitudinal direction of the vehicle and the upper limb 13 extends substantially horizontally and in the longitudinal direction of the vehicle.

The lower sheet metal shell component 9 comprises respective lower, lateral limb parts 14, 15, which are connected to each other in one piece via a lower limb 16. This lower limb 16 completes the upper sheet metal shell component 8 with the lateral limbs 11, 12 and the upper limb 13 to form a box profile 17, which runs around on the outer peripheral side and which at least substantially delimits a cavity 18.

The respective lower, lateral limb parts 14, 15 of the main body 7, which is formed by the upper sheet metal shell component 8 and the lower sheet metal shell component 9, protrude here downwards in relation to the vertical direction of the vehicle in relation to the lower limb 15 of the box profile 17 (formed by the respective lateral limbs 11, 12, the upper limb 13 and the lower limb 16). In this way—as can be seen in particular from FIGS. 3 and 4—the rear bumper crossmember 4 is also supported by means of the flange plate 6 in a lower height region, for example below a groove 19 running in the transverse direction of the vehicle, on the motor vehicle body-in-white, in particular on the rear end plate 3, and by means thereof or in extension on the relevant laterally assigned side member 2. As a result, if there is a rear impact on the motor vehicle or the bumper crossmember 4 with an accident force acting from the rear to the front in the longitudinal direction of the vehicle, the bumper crossmember 4 is also supported in its lower height region below the groove 19 via the respective lateral limb parts 14, 15 towards the front in the motor vehicle body-in-white, so that such an introduction of accident forces does not lead to an introduction of torque or to a twisting and tilting of the bumper crossmember 4 and the energy absorption elements 5 can be guided downwards in the vertical direction of the vehicle. Rather, the bumper crossmember 4 is supported particularly favorably over its at least substantially entire height, namely in the upper region via the box profile 17—formed by the lateral limbs 11, 12, the upper limb 13 and the lower limb 16 of the belt body 7 and also in the lower height region by the respective lower, lateral limb parts 14, 15. In addition to the fact that the large-format support over the entire height of the bumper crossmember 4 prevents the bumper crossmember 4 from tilting, the accident forces are additionally evenly transferred into the box profile 7 of the energy absorption element 5, so that the accident energy introduced can be distributed particularly evenly.

In particular it can also be seen from FIG. 5 that the lateral limb parts 14, 15 protrude laterally relative to the lateral limbs 11, 12 in the transverse direction of the vehicle. This results in a particularly large-format support of the bumper crossmember 4 also in its lower region. In addition, the lateral limb parts 14, 15, which are arranged at a corresponding distance from each other in the transverse direction of the vehicle, ensure good accessibility to a lower fastening opening 20 (FIG. 4), via which the flange plate 6 can be connected in the region of the rear end plate 3 to the motor vehicle body-in-white or the laterally associated rear side member 2. Also due to the fact that the lower sheet metal shell component 9 is open at the bottom between the lateral limb parts 14, 15, a particularly favorable assembly of the flange plate 6 can be carried out by means of respective screw connections on the motor vehicle body-in-white. The two sheet metal shell components 8, 9, which form the main body 7 of the energy absorption element, are connected to the flange plate 6, for example, by means of appropriate welded connections, in particular MAD welded connections 21.

FIG. 5 also shows that the lower sheet metal shell component is connected to the lower ends of the lateral limbs 11, 12 of the upper sheet metal shell component 8 in the region of the respective flanks 22 running downwards obliquely from the welded connections 10. The obliquely downwardly running flanks 22 allow water to run off easily from the box profile 17 or the cavity 18, so that no corrosion can occur in this region.

In the following case, the upper sheet metal shell component 8 and the lower sheet metal shell component 9 have respective trigger beads 23, 24, by means of which the energy absorption capability of the main body 7 or the respective energy absorption element 5 can be specifically adjusted overall in the upper or lower region. The respective trigger beads 23, 24 are therefore designed differently in the present case, both in terms of their number and their shape.

FIG. 4 also shows that the bumper crossmember 4 in the present case is also connected to the main body 7 of the respective energy absorption element 5 via respective welded connections 25. It can also be seen from FIG. 4 that on the upper side of the flange plate 6 there is provided a further fastening opening 20, by means of which the energy absorption element can also be connected to the body-in-white of the motor vehicle in the upper region.

Lastly, FIG. 6 shows, once more, in a side view, the fastening arrangement of the bumper crossmember 4 on the rear end of the motor vehicle body by means of the respective energy absorption elements 5. In particular, it can be seen here that the lower sheet metal shell component 9 protrudes slightly downwards in the vertical direction of the vehicle relative to the rear, laterally assigned side member 2. This again creates improved support or an improved introduction of force in the event that force is applied as the result of an accident.

### LIST OF REFERENCE SIGNS

1 rear end
2 side member
3 rear end plate
4 bumper crossmember
5 energy absorption element
6 flange plate
7 main body
8 sheet metal shell component
9 sheet metal shell component
10 welded connections
11 lateral limb
12 lateral limb
13 upper limb
14 lateral limb part
15 lateral limb part
16 lower limb
17 box profile
18 cavity
19 groove
20 fastening opening
21 welded connections
22 flanks
23 trigger bead
24 trigger bead
25 welded connections

1-9. (canceled)

10. An energy absorption element for supporting a bumper crossmember on a body of a motor vehicle, comprising:
a flange plate supportable on a body side;
at least one main body connected to the flange plate, which main body forms a box profile by respective lateral limbs, an upper limb and a lower limb, the box profile delimiting a cavity at least substantially,
wherein respective lateral limb parts of the main body protrude downwards relative to the lower limb of the box profile.

11. The energy absorption element according to claim 10, wherein
the lateral limbs and the upper limb of the main body are formed by an upper sheet metal shell component, and
the lateral limb parts and the lower limb of the main body are formed by a lower sheet metal shell component.

12. The energy absorption element according to claim 10, wherein
the lateral limb parts protrude laterally relative to the lateral limbs in the transverse direction of the vehicle.

13. The energy absorption element according to claim 11, wherein
the upper sheet metal shell component is connected to the lower sheet metal shell component at lower ends of the lateral limbs via respective joint connections.

14. The energy absorption element according to claim 13, wherein the joint connections are welded connections.

15. The energy absorption element according to claim 14, wherein
the lower sheet metal shell component is connected to the lower ends of the lateral limbs of the upper sheet metal shell component in a region of respective flanks running obliquely downwards from the welded connections.

16. The energy absorption element according to claim 11, wherein
the upper sheet metal shell component and the lower sheet metal shell component have different trigger beads.

17. The energy absorption element according to claim 10, wherein
a lower fastening opening is arranged on an underside of the lower limb and inside the respective lateral limb parts.

18. A fastening arrangement for fastening an energy absorption element according to claim 10 to a body of a motor vehicle.

19. The fastening arrangement according to claim 18, wherein
a lower sheet metal shell component of the main body protrudes downwards relative to a side member of the body of the motor vehicle.
